(19) United States
(12) Patent Application Publication
(10) Pub. No.: US 2002/0144260 A1
(43) Pub. Date: Oct. 3, 2002

(54) Method for adaptive data/content insertion in MPEG2 transport stream

(75) Inventor: Kavitha Vallari Devara, Ossining, NY (US)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/821,122

(22) Filed: Mar. 29, 2001

(51) Int. Cl. H04N 7/16; H04N 7/173

(52) U.S. Cl. 725/32; 725/36; 725/116; 725/136; 725/95

(57) ABSTRACT

An adaptive data insertion mechanism conducts future available bandwidth prediction/estimation by analyzing recent bandwidth in the transport stream which is consumed by general programs and inserts data by replacement of selected packets within the transport stream. Estimates of future available bandwidth are produced from periodic sampling of bandwidth utilization together with information regarding upcoming programming changes. The available bandwidth estimate is employed to prioritize and schedule data insertion within the transport stream. Scheduled data is inserted by replacement of selected packets within the received transport stream before forwarding.

### TECHNICAL FIELD OF THE INVENTION

The present invention is directed, in general, to data delivery systems and, more specifically, to insertion of localized or personalized content within general data during delivery.

### BACKGROUND OF THE INVENTION

Recent advances in digital video technology have made possible transmission of locally generated data along with video/audio to consumers by insertion into broadcast streams. Such capability enables new services and applications which enhance the digital television experience. For example, local broadcast affiliates may customize broadcast programs with local advertisements, local news and stock information updates (including “ticker” overlays), and local educational programs. Customization may extend down to the level of the individual viewer.

Content insertion/splicing devices exist which multiplex data with audio and video to insert local programs and/or commercials into broadcast streams. However, new services enabled by digital video technologies require new and efficient ways of adding data streams to broadcasts streams within the limit of a given bandwidth. An efficient, simple data insertion systems is critical for timely and opportunistic delivery of such localized and/or individualized content to the viewers, one which preferably makes the best possible use of available bandwidth.

For example, the motion pictures expert group (MPEG) standard, phase 2 (MPEG-2) is a very flexible standard permitting easy implementation of new data services without changing the underlying standard. Currently the MPEG-2 transport stream utilizes “null” packets-packets identified by the packet type identifier (“PId”) number 8191—as fillers to fill in the bandwidth not utilized by the audio/video streams or any other useful streams. Insertion of data within an MPEG-2 transport stream by replacing null packets (and any other replaceable packets) is one option for content insertion. However, simple insertion of data packets for null packets does not allow judicious use of available bandwidth, and may not suffice to insert data services efficiently without disturbing the broadcast stream.

There is, therefore, a need in the art for adaptive insertion of content within a digital broadcast streams, such as an MPEG-2 transport stream, to enable timely delivery of data and maximum utilization of available bandwidth without disturbing the broadcast stream in a destructive manner.

### SUMMARY OF THE INVENTION

To address the above-discussed deficiencies of the prior art, it is a primary object of the present invention to provide, for use in receiver, an adaptive data insertion mechanism which conducts future available bandwidth prediction/estimation by analyzing recent bandwidth in the transport stream which is consumed by general programs and inserts data by replacement of selected packets within the transport stream. Estimates of future available bandwidth are produced from periodic sampling of bandwidth utilization together with information regarding upcoming programming changes. The available bandwidth estimate is employed to prioritize and schedule data insertion within the transport stream. Scheduled data is inserted by replacement of selected packets within the received transport stream before forwarding.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a data transmission system in which adaptive content insertion within a broadcast stream is implemented according to one embodiment of the present invention;

FIG. 2 illustrates in greater detail a system for adaptive content insertion in a broadcast stream according to one embodiment of the present invention;

FIG. 3 depicts a high level flow chart for a process of adaptive content insertion in a broadcast stream according to one embodiment of the present invention;

FIG. 4 depicts a high level flowchart for a process of available bandwidth prediction or estimation during adaptive content insertion within a broadcast stream according to one embodiment of the present invention;

FIG. 5 depicts a high level flowchart for a process of prioritization and data scheduling during adaptive content insertion in a broadcast stream according to one embodiment of the present invention; and

FIG. 6 depicts a high level flowchart for a process of data insertion during adaptive content insertion in a broadcast stream according to one embodiment of the present invention.

### DETAILED DESCRIPTION OF THE INVENTION

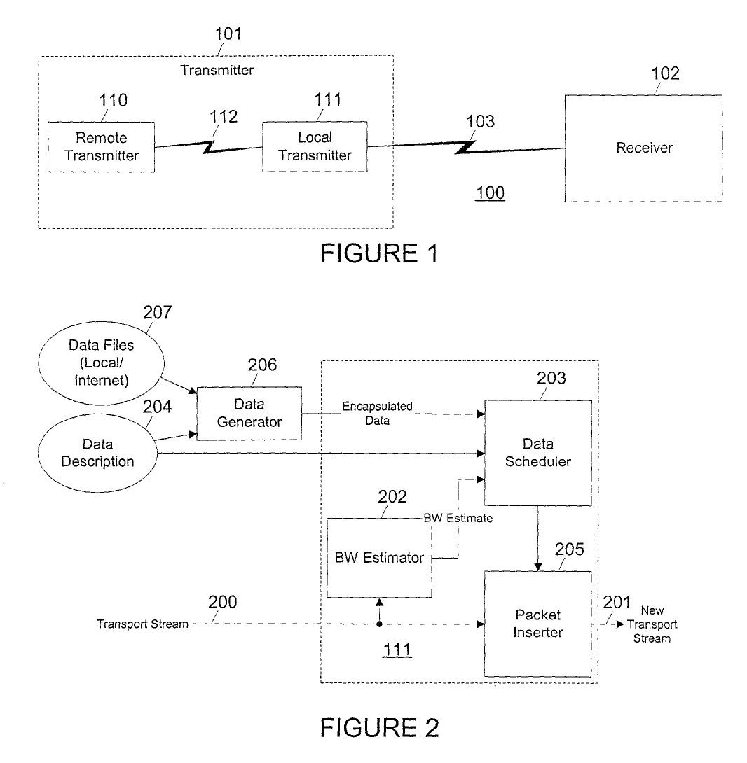

FIGS. 1 through 6, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device.

FIG. 1 depicts a data transmission system in which adaptive content insertion within a broadcast stream is implemented according to one embodiment of the present invention. Data transmission system 100 includes a transmitter 101 and a receiver 102 coupled by a communications link 103. Communications link 103 may be a wireless, air interface communications channel or a wired, packet- or circuit-switched communications network channel in accordance with the known art. In the exemplary embodiment, transmitter 101 and receiver 102 are a high definition television (HDTV) transmitter and receiver, respectively. Alternatively, however, transmitter 101 and receiver 102 may be any transmitter/receiver employed within a data transmission system (including voice, data or voice and data communications systems) in which local content insertion is performed.

Transmitter 101 in the exemplary embodiment includes a remote transmitter 110 and a local transmitter 111 coupled by a communications link 112. The terms “local” and “remote” are not intended to imply geographic location, but instead describe the relationship of the respective transmitters 111 and 110 in the transport chain with regard to the receiver 102—that is, local transmitter 111 is closer, within the transport chain, to receiver 102 than is remote transmitter 110. As with communications link 103, communications link 112 may be a wireless, air interface communications channel or a wired, packet- or circuit-switched communications network channel in accordance with the known art.

FIG. 2 illustrates in greater detail a system for adaptive content insertion in a broadcast stream according to one embodiment of the present invention. Local transmitter (or, more accurately, re-transmitter) 111 receives the initial transport stream 200 from remote transmitter 110 and inserts content to form a new transport stream 201, which is then transmitted to the receiver.

A good data insertion system should satisfy the following requirements: (1) data insertion without destructive disturbance of current programs; (2) timely data delivery; and (3) maximization of available bandwidth utilization. The present invention comprises an adaptive data insertion system for embedding multimedia application data and/or any other text data in an MPEG-2 transport stream and consists of two phases: bandwidth prediction/estimation based upon analysis of recent bandwidth consumed by programs of the transport stream, and insertion of data by replacement of selected packets (e.g., null packets or audio layer packets) representing the measure of available bandwidth.

A bandwidth (BW) estimator 202 within local transmitter 111 tracks the bandwidth consumed by each packet type identifier (PId), including replaceable packets such as null packets, counting the number of packets with each different packet type identifier during a given period. These statistics are then utilized to predict the future available bandwidth within the transport stream.

The estimate of future available bandwidth is received and employed by data scheduler 203 to prioritize and schedule the data streams which are to be inserted into the incoming initial transport stream 200. For this purpose, data scheduler 203 receives the data description 204, a profile of the data to be inserted within the incoming initial transport stream 200 which includes, for example, the name and or uniform resource locator (URL) for the data file to be inserted, the required (or desired) bit rate for transmission, the desired schedule for insertion, etc. The data to be inserted may be multimedia content such as a joint photographic experts group (JPEG) standard graphical image or an audio sound track file, or any other binary (byte-code) or text data.

Data scheduler 203 prioritizes and schedules data streams to be inserted into the incoming transport stream 200 based upon the predicted available bandwidth obtained from bandwidth estimator 202 and the required/desired bit rate obtained from the data description 204 so that the bit rate required by a particular data stream or resource is satisfied.

Once the data streams are scheduled, a packet inserter 205 within the local transmitter 111 watches for replaceable packets (e.g., null packets) within the incoming transport stream 200 and replaces those packets with data packets of the currently scheduled insertion data within new transport stream 201. Packet inserter 205 contains a list of packet types, identified by packet type identifier, which may be replaced within the incoming transport stream 200. The system may be configured with such a list by a local administrator at the local transmitter. Non-replaceable packets within the incoming transport stream 200 are simply passed through packet inserter 205 into the new transport stream 201.

The insertion data streams (data streams comprising the content to be inserted within the incoming transport stream 200) must be packaged within a data format consistent with that employed by the incoming transport stream 200, which in the exemplary embodiment is an MPEG-2 data format. Within a high-level MPEG2 data format, there may be multiple levels of data encapuslation, depending on the application. Data generator 206 obtains the raw data 207 for the content to be inserted and encapsulates the data in an MPEG-2 data format, such as an MPEG-2 section or packet (i.e., 188 byte packets). Data generator 206 need not necessarily form part of local transmitter 111, but instead could be an external entity preparing the data packets in a specified format. Similarly, data description 204 and data files 207 for the insertion content need not originate locally within local transmitter 111, but may instead be retrieved from a remote facility utilizing, for example, and Internet connection. However, data generator 206, data description 204, and data files 207 may optionally form part of and/or be stored within local transmitter 111.

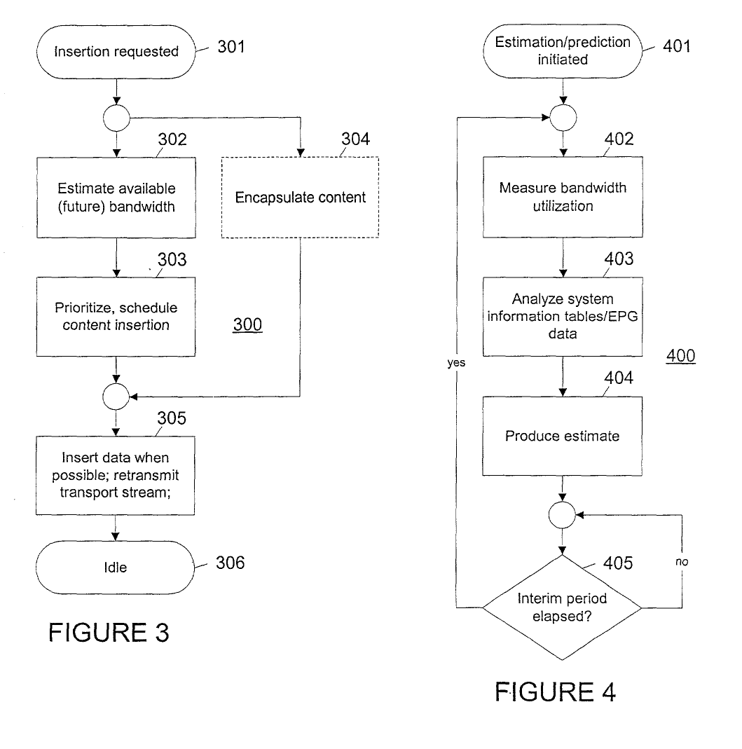

FIG. 3 depicts a high level flow chart for a process of adaptive content insertion in a broadcast stream according to one embodiment of the present invention. The process 300, performed by local transmitter 111 in FIG. 2, begins with a request being received (step 301) by a local transmitter for future content insertion in a transport stream being relayed by the local transmitter. An estimate or prediction of future bandwidth (step 302) available for future content insertion is first conducted based on current characteristics of the transport stream. The data for the requested content insertion is then prioritized and scheduled (step 303) based on the predicted/estimated future available bandwidth. The data for the requested content insertion may optionally be encapsulated (step 304) concurrently with the steps of bandwidth estimation and prioritization/scheduling, either within the local transmitter or within a remote entity. Alternatively, encapsulation of the insertion data may be performed before or after the steps of bandwidth estimation and prioritization/scheduling.

The data for the insertion content is then inserted within the transport stream as possible (step 305) by replacement of replaceable packets within the incoming transport stream, and the modified transport stream is forwarded to the receiver or next re-transmitter. The process then becomes idle (step 306) until a subsequent content insertion request is received. Those skilled in the art will recognize that multiple content insertion requests may be processed as described above in a concurrent or overlapping (either fully or partially) manner.

FIG. 4 depicts a high level flowchart for a process of available bandwidth prediction or estimation during adaptive content insertion in a broadcast stream according to one embodiment of the present invention. The process 400, corresponding to step 302 in FIG. 3 and performed by bandwidth estimator 202 in FIG. 2, begins with bandwidth estimation being initiated (step 401). Initially, bandwidth utilization is measured (step 402) over a short period of time such as, for example, 1 second (approximately 12,830 MPEG-2 transport stream packets for a High Definition Digital Television channel). Bandwidth utilization is measured by counting the number of packets for each unique packet type identifier which are detected during the measurement interval, then computing the number of replaceable packets within the transport stream during the measured interval.

For television broadcast systems, which are the subject of the exemplary embodiment, bandwidth utilization is more or less uniform throughout a particular program, but often undergoes a sharp change when switching from one program to another (e.g., from a news program to an action movie or vice versa). Such changes may be predicted, however, by analyzing system information tables and/or electronic program guide (EPG) data (step 403) such as the event information table (EIT) which provides the lineup of current and upcoming programs. Resources similar to the system information tables, such as history tables tracking bandwidth utilization as a function of the time of day, may be employed for other environments.

Using the analysis of the system information tables together with the calculation of replaceable packets, an estimate or prediction of the future available bandwidth is produced (step 404). Since bandwidth measurement is conducted periodically, the interval between sampling periods is allowed to elapse (step 405) before repeating the bandwidth utilization measurement step and generating an updated estimate of future available bandwidth. The process may continue until terminated by an external process.

Experiments conducted on Advanced Television Systems Committee (ATSC) high definition (HD) content reveal that the average bandwidth utilization of a television program is, to some degree, related to the type of program. For example, the average bandwidth utilization of a news program is different from that of a movie. Combined with the programming information within the EIT, the recent (last one-minute sample) statistics may be employed to estimate the bandwidth available for the next program, which usually lasts about 30 minutes. Accordingly, if estimates are generated in ten minute intervals, the estimate may, depending upon the time of the estimate, be useful for the next 10, 20 or 30 minutes.

The absolute value of the bandwidth availability estimate depends on the video quality of the program. Relative bandwidth information between two programs is employed to predict the future bandwidth, with some exceptions such as commercials embedded within a television program. Accuracy of the bandwidth availability estimates may be improved by discarding spurious peaks and valleys within the (ongoing) bandwidth estimation process, and/or by combining recognition of such spurious peaks with other commercial detection (cut-detection) methods to derive more accurate information regarding the overall bandwidth utilization of a particular program.

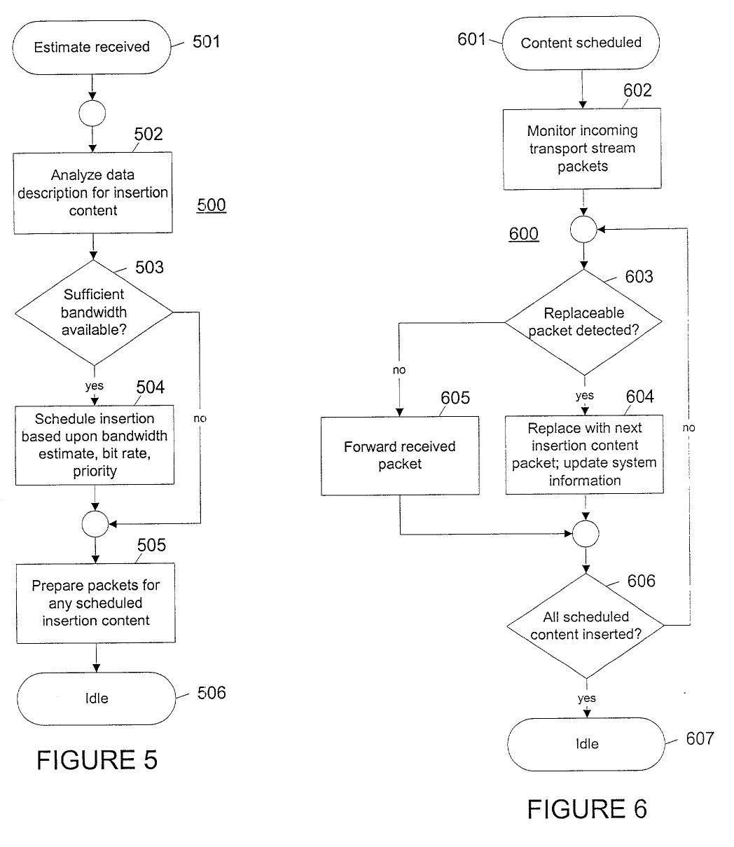

FIG. 5 depicts a high level flowchart for a process of prioritization and data scheduling during adaptive content insertion in a broadcast stream according to one embodiment of the present invention. The process 500, corresponding to step 303 in FIG. 3 and performed by data scheduler 203 in FIG. 2, begins with receipt of a bandwidth estimate (step 501) from the bandwidth estimator. The data description for the requested insertion content is then analyzed (step 502) and a determination is made (step 503) as to whether sufficient bandwidth is available for insertion of the specified content (or contents) given the associated bandwidth, timing and bit rate requirements.

The data description will typically consists of: the name (and URL) of the data file for the content to be inserted (the scheduler may pre-fetch content if the data is not local) the size of the data file; the desired (or required) bit rate; the frequency of insertion, if the content is to be transmitted within the transport stream repeatedly; the order of sending data streams for specific insertion content (e.g., sending data stream 1 before sending data stream 2 at the same bit rate); and the urgency or priority of the insertion content. From the above parameters, a determination may be made if sufficient bandwidth is estimated to be available for insertion.

If the bandwidth availability estimate predicts that sufficient bandwidth will be available during the relevant period for insertion of at least one block of insertion content based on the size of the respective insertion content (bandwidth requirement) and the desired bit rate, insertion of the respective content is scheduled (step 504). Where insertion of multiple blocks of content is requested, each block is scheduled for insertion based on the associated urgency/priority from the data description for that block, the (remaining) available bandwidth within the bandwidth availability estimate, and the particular bit rate requirements for the respective block of content (obtained from the data description).

If the predicted available bandwidth is insufficient for insertion of a requested block of content without degradation of or destruction within the content quality for the incoming transport stream, insertion is not scheduled for that content. However, an optional override may be implemented for urgent local information such as updating local severe weather information, preferably with minimal impact on the quality for the broadcast stream into which the content is inserted. Similarly, an override for scheduled content may be implemented for higher priority insertion content for which insertion is requested after scheduling of previously requested insertion content.

The data scheduler may also be required to prepare data transport stream packets (188 byte packets) for content scheduled to be inserted (step 505) and then becomes idle (step 506) until an updated future bandwidth availability estimate (or new request for content insertion) is received.

FIG. 6 depicts a high level flowchart for a process of data insertion during adaptive content insertion in a broadcast stream according to one embodiment of the present invention. The process 600, corresponding to step 305 in FIG. 3 and performed by packet inserter 205 in FIG. 2, begins with content being scheduled for insertion (step 601) Incoming transport stream packets are checked (step 602) to determine if the packet is a replaceable packet (step 603), as identified by a packet type identifier which has been designated as corresponding to a replaceable packet (such as a null packet).

If a particular packet is found to be a replaceable packet, a packet from the packet stream scheduled and prepared by the data scheduler is inserted (step 604) in place of the replaceable packet within the transport stream forwarded to the receiver. Additionally, the relevant system information—mostly within system information packets such as the program map table (PMT) packets—should be modified to include identification of the newly inserted data stream(s). Modification of system packets is performed by either sending a new systems information table with an updated version number or by replacing the existing systems tables with utilizing new systems tables packets.

Care must be taken during packet insertion to ensure that packet type identifiers assigned to new data streams do not conflict with existing packet type identifiers. Some packet type identifier information for the inserted data stream(s) may not appear in the program map table, but may appear in other tables instead. For instance, some data streams specific to an application may be sent without including the packet type identifier within standard tables such as the program map table, such as when a service provider sends a data stream with a “hard-coded” packet type identifier understood only by some receivers, a common case given the flexibility of MPEG-2 the systems layer.

The present invention provides a general purpose system for content insertion and replacements in an MPEG-2 transport stream. This may be implemented in C++ using object-oriented methodology to be very flexible and usable in various configurations such as the remultiplexer, demultiplexer, etc., and is easily extendable to accommodate new protocol stacks.

Although disclosed in the context of MPEG-2 systems, the present invention is also suitable for inserting data into MPEG-4 streams, particularly since MPEG-4 is based on scalable, object level encoding requiring finer granularity of data insertion. The present invention is also relevant to MPEG-7 based applications in the context of meta data insertion.

The present invention is motivated by the need for inserting low-bandwidth data services in a timely manner without disturbing the broadcast stream while judiciously using available bandwidth. For example, data services including HyperText Markup Language (HTML) pages, Extensible Markup Language (XML) files, and downloadable files associated with video content require estimation of available bandwidth for prioritization of data services and timely delivery because some data services are tightly synchronized with video content.

Numerous applications and systems may advantageously employ the present invention. Insertion of application data such as Java class files, image files, triggers or text data associated with an application/user service may employ the present invention. Similarly the present invention may be utilized to insert local advertisement information into a transport stream, or to replace a general advertisement stream with a localized or personalized advertisement stream. Replacement of an audio stream with the audio content in a different language, although requiring tighter synchronization between the audio and video, may be performed utilizing the present invention, assuming that the insertion audio stream has approximately the same timing as the stream being replaced. Closed-caption information in a different language may also be inserted.

It is important to note that while the present invention has been described in the context of a fully functional hard-ware based system and/or network, those skilled in the art will appreciate that the mechanism of the present invention is capable of being distributed in the form of a machine usable medium containing instructions in a variety of forms, and that the present invention applied equally regardless of the particular type of signal bearing medium utilized to actually carry out the distribution. Examples of machine usable mediums include: nonvolatile, hard-coded type mediums such as read only memories (ROMs) or erasable, electrically programmable read only memories (EEPROMs), recordable type mediums such as floppy disks, hard disk drives and compact disc read only memories (CD-ROMs) or digital versatile discs (DVDs), and transmission type mediums such as digital and analog communication links.

Although the present invention has been described in detail, those skilled in the art will understand that various changes, substitutions and alterations herein may be made without departing from the spirit and scope of the invention in its broadest form.

What is claimed is:

1. For use in a transceiver, an adaptive data insertion mechanism for inserting data within a transport stream without destructive disturbance comprising:
a bandwidth estimator producing an estimate of future available bandwidth within said transport stream;
a scheduler prioritizing and scheduling insertion of content to be inserted within said transport stream based upon said estimate of future available bandwidth and characteristics of said insertion content; and
an insertion unit inserting scheduled insertion content within said transport stream by replacement of selected replaceable content within said transport stream to form a new transport stream.

2. The adaptive data insertion mechanism as set forth in claim 1 wherein said bandwidth estimator produces said estimate of future available bandwidth from periodic bandwidth utilization measurements for said transport stream and information regarding current and future programming to be transmitted by said transport stream.

3. The adaptive data insertion mechanism as set forth in claim 1 wherein said insertion unit replaces selected packets within said transport stream which include one of one or more selected packet type identifiers with packets for said insertion content while passing packets which include packet type identifiers other than said selected packet type identifiers to form said new transport stream.

4. The adaptive data insertion mechanism as se forth in claim 3 wherein said insertion unit replaces null packets within an MPEG-2 transport stream.

5. A transceiver comprising:
a input connection receiving an incoming transport stream;
an output connection from which a new transport stream is transmitted, said new transport stream including at least portions of said incoming transport stream; and
an adaptive data insertion mechanism for inserting data within said incoming transport stream without destructive disturbance comprising:
a bandwidth estimator producing an estimate of future available bandwidth within said incoming transport stream;
a scheduler prioritizing and scheduling insertion of content to be inserted within said new transport stream based upon said estimate of future available bandwidth and characteristics of insertion content obtained from a source separate from said incoming transport stream; and
an insertion unit inserting scheduled insertion content within said new transport stream by replacement of selected replaceable content within incoming transport stream to form said new transport stream.

6. The transceiver as set forth in claim 5 wherein said bandwidth estimator produces said estimate of future available bandwidth from periodic bandwidth utilization measurements for said incoming transport stream and information regarding current and future programming to be transmitted by said incoming transport stream.

7. The transceiver as set forth in claim 5 wherein said insertion unit replaces selected packets within said incoming transport stream which include one of one or more selected packet type identifiers with packets for said insertion content while passing packets which include packet type identifiers other than said selected packet type identifiers to form said new transport stream.

8. The transceiver as set forth in claim 6 wherein said insertion unit replaces null packets within an MPEG-2 transport stream.

9. For use in a transceiver, a method of adaptive data insertion within a transport stream without destructive disturbance comprising:
producing an estimate of future available bandwidth within the transport stream;
prioritizing and scheduling insertion of content to be inserted within the transport stream based upon the estimate of future available bandwidth and characteristics of insertion content; and
inserting scheduled insertion content within the transport stream by replacement of selected replaceable content within the transport stream to form a new transport stream.

10. The method as set forth in claim 9 wherein the step of producing an estimate of future available bandwidth within the transport stream further comprises:
producing the estimate of future available bandwidth from periodic bandwidth utilization measurements for the transport stream and information regarding current and future programming to be transmitted on the transport stream.

11. The method as set forth in claim 9 wherein the step of inserting scheduled insertion content within the transport stream by replacement of selected replaceable content within the transport stream to form a new transport stream further comprises:
replacing selected packets within the transport stream which include one of one or more selected packet type identifiers with packets for the insertion content while passing packets which include packet type identifiers other than the selected packet type identifiers to form the new transport stream.

12. The method as set forth in claim 11 wherein the step of replacing selected packets within the transport stream which include one of one or more selected packet type identifiers with packets for the insertion content while passing packets which include packet type identifiers other than the selected packet type identifiers to form the new transport stream further comprises:
replacing selected null packets within an MPEG-2 transport stream.

13. A computer program product within a computer usable medium for adaptive data insertion within a transport stream without destructive disturbance comprising:
instructions for producing an estimate of future available bandwidth within the transport stream;
instructions for prioritizing and scheduling insertion of content to be inserted within the transport stream based upon the estimate of future available bandwidth and characteristics of insertion content; and
instructions for inserting scheduled insertion content within the transport stream by replacement of selected replaceable content within the transport stream to form a new transport stream.

14. The computer program product as set forth in claim 13 wherein the instructions for producing an estimate of future available bandwidth within the transport stream further comprise:
instructions for producing the estimate of future available bandwidth from periodic bandwidth utilization measurements for the transport stream and information regarding future programming to be transmitted on the transport stream.

15. The computer program product as set forth in claim 14 wherein the instructions for inserting scheduled insertion content within the transport stream by replacement of selected replaceable content within the transport stream to form a new transport stream further comprise:
instructions for replacing selected packets within the transport stream which include one of one or more selected packet type identifiers with packets for the insertion content while passing packets which include packet type identifiers other than the selected packet type identifiers to form the new transport stream.

16. The computer program product as set forth in claim 15 wherein the instructions for replacing selected packets within the transport stream which include one of one or more selected packet type identifiers with packets for the insertion content while passing packets which include packet type identifiers other than the selected packet type identifiers to form the new transport stream further comprise:
instructions for replacing selected null packets within an MPEG-2 transport stream.

17. A data transport stream comprising:
a first portion derived from a transport stream; and
a second portion derived from insertion content, wherein a ratio of the first portion to the second portion is determined by an estimate of available bandwidth within said transport stream representing selected replaceable content within said transport stream and by insertion of said insertion content by replacement of said selected replaceable content within said transport stream with portion of said insertion content to form said data transport stream.

18. The data transport stream as set forth in claim 17 wherein said estimate of available bandwidth within said transport stream is derived from periodic bandwidth utilization measurements for said transport stream and information regarding future programming to be transmitted on said transport stream.

19. The data transport stream as set forth in claim 17 wherein:
said first portion further comprises packets within said transport stream which include packet type identifiers other than one or more selected packet type identifiers; and
said second portion further comprises packets for said insertion content in place of packets within said transport stream which include one of said one or more selected packet type identifiers.

20. The data transport stream as set forth in claim 19 wherein said second portion further comprises packets for said insertion content in place of null packets within an MPEG-2 transport stream forming the transport stream.
